(19) United States
(12) Patent Application Publication
(10) Pub. No.: US 2002/0066797 A1
(43) Pub. Date: Jun. 6, 2002

(54) Breathable air fire extinguisher

(76) Inventor: Timothy Taylor, Red Bank, NJ (US)

Correspondence Address: Timothy Taylor, 258 NEWMAN SPRINGS ROAD, Red Bank, NJ, 07701, US

(21) Appl. No.: 09/553,801

(22) Filed: Apr. 21, 2000

Related U.S. Application Data
(60) Provisional application No. 60/130,687, filed on Apr. 23, 1999.

(51) Int. Cl. B05D 1/00

(52) U.S. Cl. 239/1

(57) ABSTRACT

A process that changes normal atmospheric air into an effective breathable fire extinguisher. This process involves a unit that draws in normal atmospheric air and consumes a percentage of the oxygen from it. This process will be able to create this fire extinguishing air anywhere there's an abundance of normal air. This process will also be capable of leaving this air at an oxygen level that is considered to be breathable to mammalian life and more particularly human life. From 21% oxygen down to between 15% to 12% by volume. Making this process capable of creating fire extinguishing air, that remains breathable and won't cause any extra damage to personal effects.

### BACKGROUND OF THE INVENTION

Several solutions to the problem of extinguishing fire in confined spaces where mammalian life, in particular, human life, are know in the prior art. Basically, these solutions revolve around using a gas product that produces a combustion suppressant atmosphere in a confined space. All of these gas mixtures have to be manufactured, then bottled and all lack the flexibility of being able to be created at the scene of a fire, in unlimited amounts. Some are considered breathable, but all still add some sort of chemicals or additive. There are none that use only air.

U.S. Pat. No. 4,807,706 discloses for preventing, controlling and or extinguishing fires in confined space, without damage to equipment, loss of habitability for personnel, loss of consciousness for personnel or a significant impact on the mental acuity of personnel in the confined space, which comprises introducing carbon dioxide and another inert gas, e.g. nitrogen or helium, to the confined space to lower the oxygen content to a concentration in the range between 8% and 15% by volume while increasing the carbon dioxide content of the confined space to an amount in the range of 2% to 5% by volume. The combination of reducing oxygen concentration in the gaseous environment of the confined space works together to sustain mammalian life, in particular, maintaining consciousness and mental acuity while not supporting, i.e. extinguishing flame.

U.S. Pat. Discloses a habitable atmosphere, which does not sustain combustion of flammable material of the non-self-sustaining type and which is capable of sustaining mammalian life, consisting essential of air, a perfluoroalkane selected from the group consisting of carbon tetrafluoride, hexafluoroethan, octfluoropropane, and mixture thereof, and makeup oxygen in an amount from about 0 to the amount required to provide, together with the oxygen present in the air, sufficient total oxygen to sustain mammalian life. The perfluoroalkane should be present in an amount sufficient to impart to the atmosphere a heat capacity per mol of total oxygen which is sufficient to suppress combustion of flammable material present in the enclosed compartment containing the atmosphere. The patent also discloses a method for preventing abd controlling fire in combined air-containing compartment while maintaining the compartment habitable by mammalian life, which comprises, introducing into the air carbon tetrafluoride, hexafluoroethane, octafluoropropane or mixture thereof, in an amount sufficient to privide a heat capacity per mol of total oxygen which is sufficient to suppress combustion of total oxygen which is sufficient to suppress combustion of the flammable materials present in the compartment and, additionally, introducing oxygen if and as required, to make up with the oxygen available in the air sufficient total oxygen available in the sufficient total oxygen to sustain mammalian life.

U.S. Pat. No. 3,840,667 discloses an oxygen -containing atmosphere which will not support combustion but will sustain mammalian life. The oxygen-containing atmosphere comprises a mixture of sufficient oxygen to sustain mammalian life; an inert, stable, high heat capacity of polyatomic (a perfluoroalkane0 gas in an amount which provides the oxygen-containing atmosphere with a total heat capacity per mot of oxygen of at least 40 calories per C. measured at 25 C. and constant pressure; and helium in an amount of from about 5% to the balance up to 100%. All percentages are in mol %. The atmosphere disclosed in the patent claims to be used in sustaining mammalian life within any closed system wherein fire hazards would normally be present.

U.S. Pat. No. 3,893,514 discloses a system and method of adding nitrogen under pressure to a confined area including a habitable atmosphere to suppress a fire without any deleterious effect on humans within the environment in which the fire is suppressed. In adding nitrogen to the confined area, the partial pressure of oxygen remains the same for human life, if necessary whereas the percent by volume oxygen is lowered to a point which is not sufficient to support combustion of burning elements. Therefore, life is sustained while the fire is suppressed without any harmful effect on humans.

### SUMMARY OF THE INVENTION

The present invention relates to a process that changes normal atmospheric air, into an effective fire extinguisher. This process involves a unit that force's air to go through a series of events. This unit will draw in normal air at 21% oxygen and force it past and in effect feeds oxygen to a natural or propane gas flame or other fuels. This gas flame will consume some of the oxygen from the air as it passes. By having a controlled air flow, along with a controlled gas flow, you could therefore have a controlled flame and by controlling the size of the flame, this unit can consume a predetermined amount of oxygen from the air on a continuous basis. More precisely, by setting the gas flow to a level that consumes 6% of the oxygen from the air passing through this unit, the air will now have an oxygen concentration level of 15%. After this air has cooled, at 15% or lower, the oxygen concentration level falls too low to support combustion in most flammable household materials. Allowing this air to act as an effective fire extinguisher and still being capable of supporting human life, in cases were humans are involved in fire emergencies.

### DETAILED DESCRIPTION OF THE INVENTION

Using this process to create fire extinguishing air will solve most of the problems we have in fire extinguishing at this time. Normal fire extinguishing techniques require the use of water, which is very destructive, causing water damage to any water sensitive items it comes in contact with. Other methods require the use of gases that are considered to be toxic to human if forced to breathe them, like halons and carbon dioxide gas fire extinguishers. Plus these products have to be manufactured and bottled and are limited to the amount of extinguishing gas that would be available at the scene of a fire. The present invention involves using normal atmospheric air to extinguish fires, air that can still be considered breathable to mammalian life, more particularly human life in cases where people are involved in fire emergencies. Using air as a fire extinguisher allows it to be capable of covering every corner of interior space, including following fire inside of vents and walls. It won't cause any additional damage to computers, paintings, furniture and pictures. Some of these items are impossible to replace after being consumed by fire. Since this process can create fire extinguishing air any place there is an abundance of normal air, this process could take place at the scene of a fire.

The present invention relates to a process that changes normal atmospheric air, into an effective fire extinguisher. This process involves a unit that will force air to go through a series of events. This unit will draw in normal air, which consist of 21% oxygen and forces it past and in effect feeds oxygen to a natural or propane gas flame or other fuels. This gas flame will consume some of the oxygen from the air as it passes. By having a controlled the air flow, along with a controlled gas flow, you could therefore have a controlled flame. By controlling the size of the flame, this unit can consumes a predetermined amount of oxygen from the air that passes through, on a continuous basis. Now by setting the gas flow to a level that consumes 6% of the oxygen passing through this unit, the effected air will now have an oxygen level of 15%. At 15% or lower, the oxygen concentration level falls too low to support combustion in most flammable household materials, allowing this air to act as a fire extinguisher. In U.S. Pat. No. 4,807,706 it is shown that with the oxygen level at 12% to 15% air can still be considered breathable and capable of extinguishing flames. If no humans were involved in the fire, then lowering the oxygen content more would result in air that would be increasingly more effective in extinguishing fires.

The act of consuming 6% or more of the oxygen from the air inside of this unit, will result in an increase of the temperature to a level of 500 degrees or more. This air will have to be cooled down to an appropriate temperature. Which could be any temperature found to be effective in fighting fire and yet still tolerable to anyone who might come into contact with this air, maybe 120 degrees or colder. Preferably, the colder the better, as to aid in cooling the structure down as fast as possible.

Over 99.9% of the finished product is still normal, free air. Aiding in keeping the operating cost of this unit low and dispelling the thought of harmful amounts of pollutants existing in the oxygen depleted air. Considering this leaves less than 0.1% of space, by volume, for impurities, such as carbon monoxide from the combustion process.

The only operating cost would be electricity and the fuel consumed in the process of making the oxygen depleted air. Natural gas, propane gas and appliances that require their use are already widely excepted for household use, for example, gas stoves, ovens, clothes dryers, hot water heaters, furnaces. All of these appliance are considered to be safe and practical to operate in the average household, aiding in proving that this unit could be designed to be safe, reliable and cost effective.

I claim:

1. A process that changes normal atmospheric air into an effective breathable fire extinguisher. This process involves a unit that draws in normal air and forces it to pass and in effect feed a natural or propane gas flame or other fuels.

2. This gas flame will consume a percentage of the oxygen from the air on a continuous basis lowering it from 21% down to 15% or more.

3. After this air has cooled, the air exiting can be used to extinguish fires.
